(19) United States
(12) Patent Application Publication
(10) Pub. No.: US 2015/0369429 A1
(43) Pub. Date: Dec. 24, 2015

(54) FACTORY COMPRESSED AIR SUPPLIES

(71) Applicant: SMC Pneumatics (Australia) Pty Ltd, Castle Hill (AU)

(72) Inventor: William Tybo BLYTH, Fletcher (AU)

(21) Appl. No.: 14/475,008

(22) Filed: Sep. 2, 2014

(30) Foreign Application Priority Data
Jun. 23, 2014 (AU) 2014 203 400

(51) Int. Cl. F17D 1/04; G05D 7/00; G05D 16/00; F17D 1/07

(52) U.S. Cl. CPC F17D 1/04; F17D 1/07; G05D 7/00; G05D 16/00

(57) ABSTRACT

A factory compressed air supply system and method are disclosed in which workstations (6) which intermittently draw compressed air from a branched network (4, 14) of air supply lines are arranged into groups, each supplied by a group branch air line (14). A group capacitive regulator (12) is interposed in each group branch line (14) and supplied by a compressor connected to the main air supply line (4). The group capacitive regulator takes the form of an air tank (32), an inlet flow controller (25), and an outlet flow regulator (30) and serves to decouple the main supply line (4) from the individual workstations (6). As a result the factory supply pressure can be lowered with consequent economic savings.

### FIELD OF THE INVENTION

The present invention relates to factory compressed air supplies and, in particular, to the reduction of the cost of providing such supplies.

### BACKGROUND ART

Almost all factories have a compressed air supply system with a compressor room having a compressor which supplies compressed air to a branch network of air supply lines which extend around the factory to a multiplicity of workstations. The workstations typically use the compressed air as a supply of energy to operate one or more air cylinders to perform a multitude of repetitive tasks at various intervals of time. Thus each workstation intermittently draws air from the branch network in order to support the pneumatic operation of the workstation. The supply compressor has a tank which maintains a reservoir of compressed air and when the pressure of the tank, termed the supply pressure, drops below a predetermined threshold, then the compressor is re-energised and operates for a short period in order to restore the supply pressure. Thus the operation of the supply compressor is cyclical. This consumes a large amount of electricity since the electric motor used to drive the supply compressor normally draws a large starting current. The cost of this electricity consumption is a significant factor in the monetary budgets of most factories. Indeed, in countries such as Australia it is thought that approximately 10% of all consumption of electrical power goes towards the supplying of compressed air.

### GENESIS OF THE INVENTION

The genesis of the present invention is a desire to reduce the economic cost of running such a factory air supply system.

### SUMMARY OF THE INVENTION

In accordance with a first aspect of the present invention there is disclosed a method of reducing the supply pressure, and hence cost, of a factory air supply for a factory having a multiplicity of workstations each of which is pneumatically intermittently operable and inter-connected with said factory air supply via a branched network of said factory air supply comprising air supply lines, said factory air supply comprising at least one supply compressor, said method comprising the steps of:
allocating said workstations into a plurality of groups, each of said groups having at least one workstation and each of said groups having a corresponding group branch air line which supplies said group from, and forms part of, said branched network,
interposing between each group branch air line and the remainder of said branched network a group capacitive regulator, each said group capacitive regulator comprising a series connected inlet flow controller, a group air tank and an outlet flow regulator,
whereby the workstation(s) of each group intermittently draw air for their operation from the corresponding said group air tank which is independently replenished from said supply compressor to thereby at least partially isolate the factory air supply from the individual workstations flow demands.

In accordance with a second aspect of the present invention there is disclosed a factory air supply system for a multiplicity of workstations each of which is pneumatically intermittently operable, said system comprising:
at least one supply compressor;
a branched air supply network comprising air supply lines;
a multiplicity of said workstations allocated into a plurality of groups, each of said groups having at least one workstation and each having a corresponding group branch air line which supplies said group from, and forms part of, said branched network;
a group capacitive regulator for each said group interposed between each group branch air line and the remainder of said branched network; and
each said group capacitive regulator comprising a series connected inlet flow controller, a group air tank and an outlet flow regulator.

In accordance with a third aspect of the present invention there is disclosed a group capacity regulator comprising a series connected inlet flow controller, a group air tank, and an outlet flow regulator.

### BRIEF DESCRIPTION OF THE DRAWINGS

A preferred embodiment of the invention will now be described, by way of example only, with reference to the accompanying drawings in which:

FIG. 1 is a schematic representation of a prior art factory air supply system,

FIG. 2 is a set of graphs of the factory supply pressure, an individual machine or workstation inlet pressure, and the flow rate of the individual machine, all as a function of time for one of the workstations illustrated in FIG. 1.

FIG. 3 is a schematic diagram similar to FIG. 1 but illustrating the factory air supply system after the installation of group capacitive regulators in accordance with the preferred embodiment,

FIG. 4 is a perspective view of a group capacitive regulator,

FIG. 5 is a pneumatic circuit diagram of the group capacitive regulator of FIG. 4, and

FIG. 6 is a set of graphs similar to that of FIG. 2 but illustrating the operation after the initial installation of the group capacitive regulators.

### DETAILED DESCRIPTION

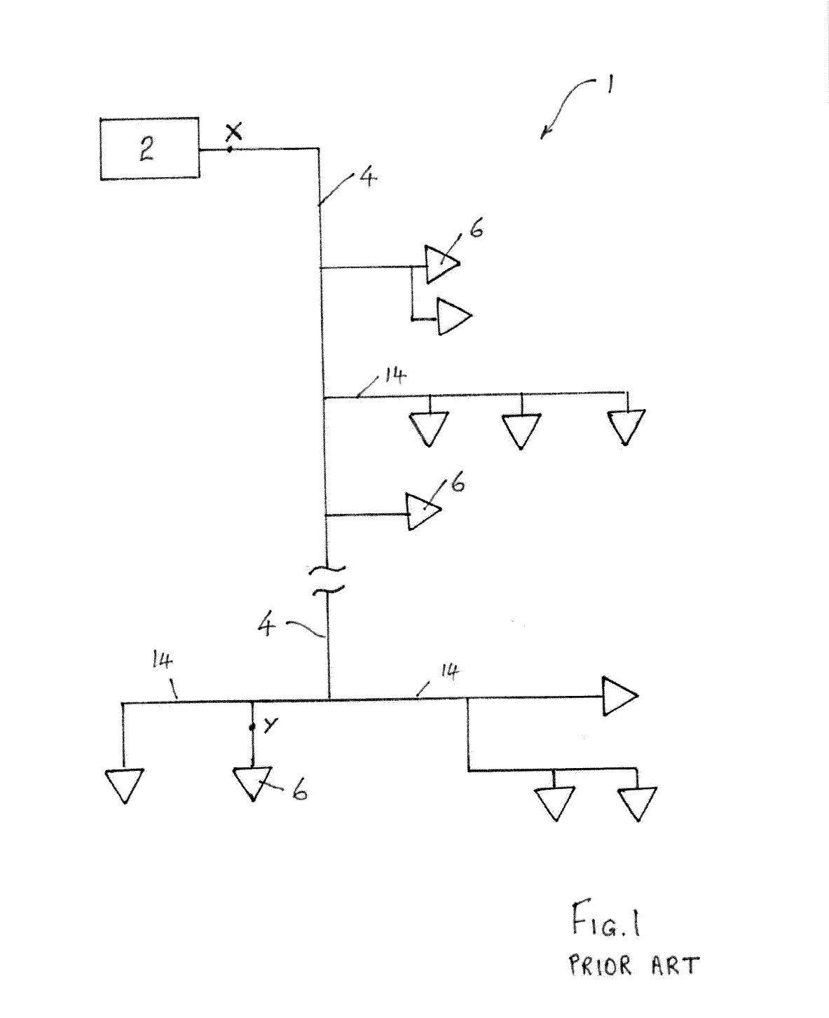

As seen in FIG. 1, a prior art factory air supply system 1 take the form of a supply compressor 2 which feeds into a branched network of air supply lines in the form of a main line 4 and a number of branch lines 14. The branch air lines 14 supply individual workstations 6.

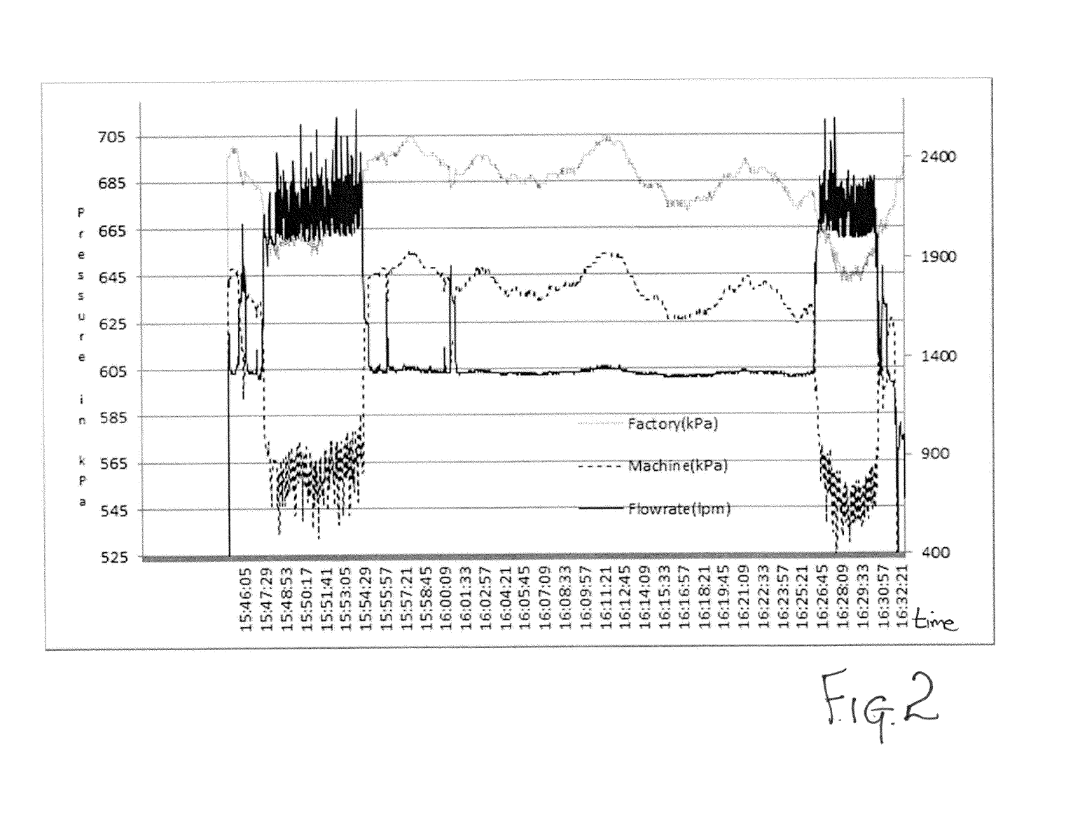

In order to produce the graph of FIG. 2, monitoring devices were installed in the air supply lines at two locations X and Y respectively. At location X the pressure of the factory air supply was measured and this results in the upper line of the graph of FIG. 2. A typical factory air supply varies between approximately 650 and 800 kPa and the factory air supply is within this range.

At location Y the monitoring equipment measured both the pressure supplied to the individual workstations or machine 6 and the flow rate drawn by an individual workstation or machine 6 in litres per minute as indicated on the right hand scale in FIG. 2.

It will be seen from FIG. 2 that the machine pressure substantially follows the factory supply pressure and this represents the pressure drop in the air supply main line 4 between the locations X and Y. In addition, when the flow drawn by the machine 6 substantially increases, simultaneously both the factory supply pressure and the machine pressure drop. Typically the pressure drop during periods of high flow demand is in the vicinity of 80-100 kPa.

It will be seen from the graphs of FIG. 2 that the machine pressure is substantially coupled to the factory supply pressure and that the factory supply pressure is very dependent upon episodes of high flow demand.

Furthermore, the factory supply pressure is very expensive to produce since every 14 kPa which is required to be supplied consumes approximately 1% of the power utilised to compress the air for the factory air supply system 1.

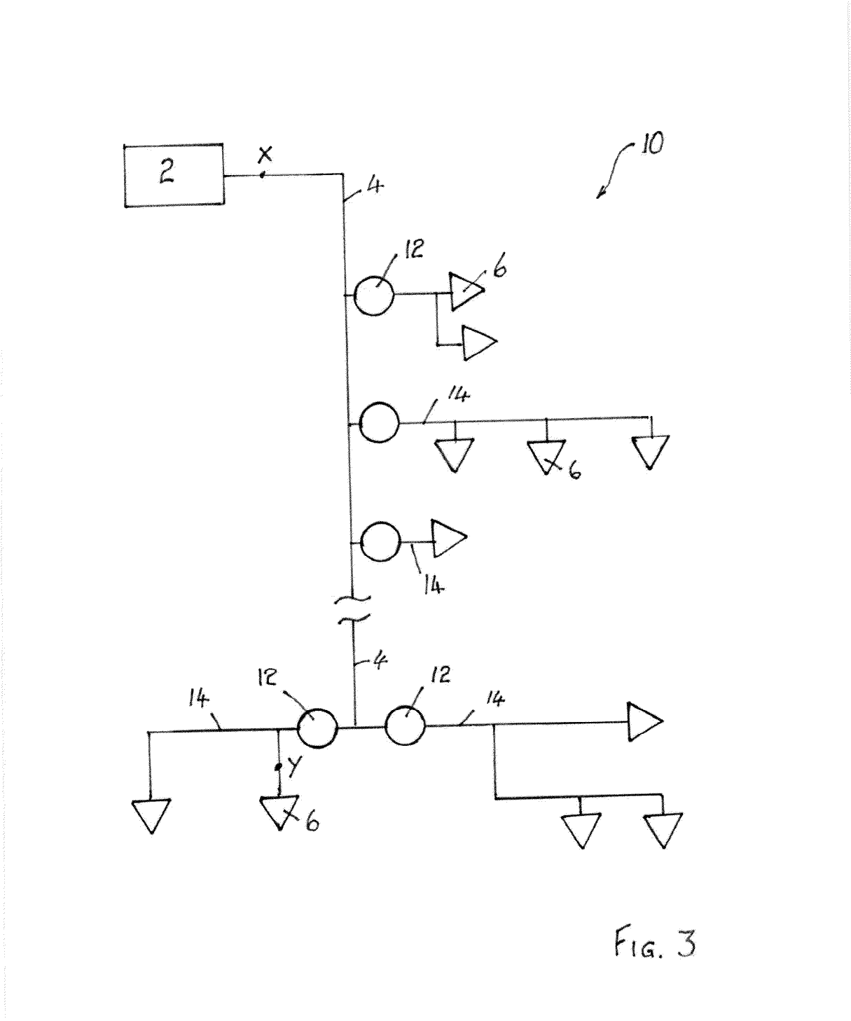

Turning now to FIG. 3, a modified factory air supply system 10 is illustrated in which the individual workstations 6 have been identified as belonging to individual groups with each group consisting of one or more workstations 6. In the branch air supply line 14 leading to each group, a group capacitive regulator 12 is interposed between the main line 4 and the branch line 14.

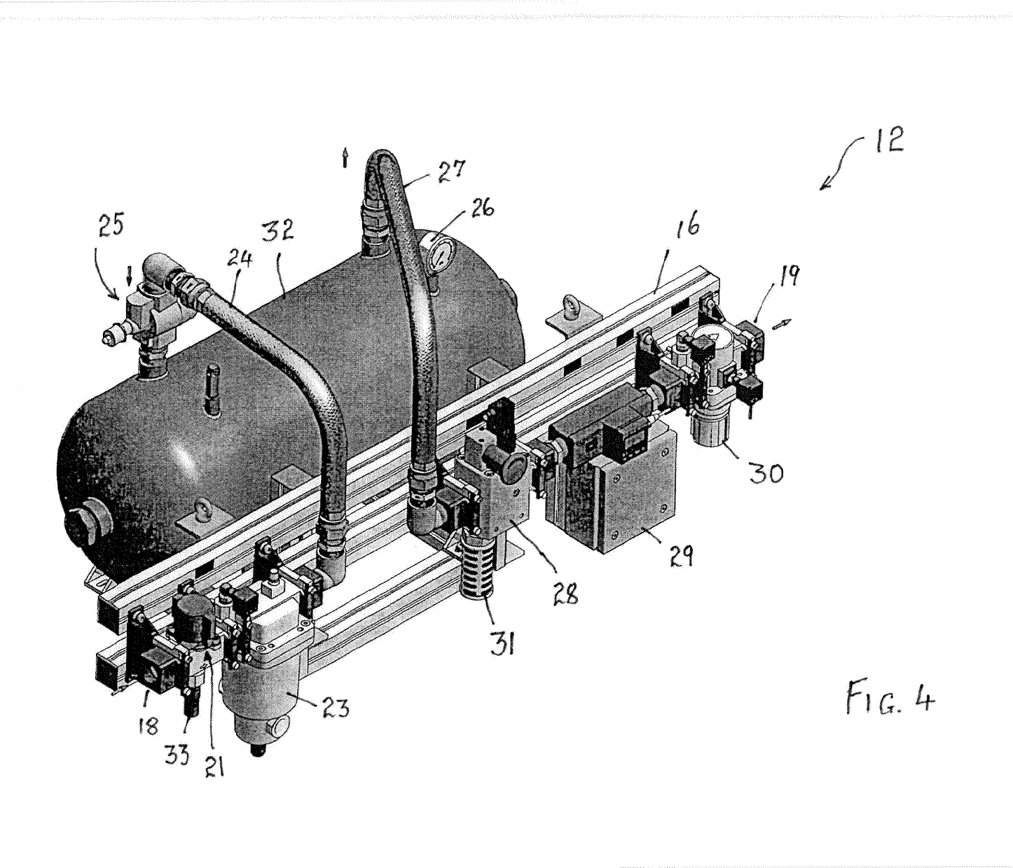

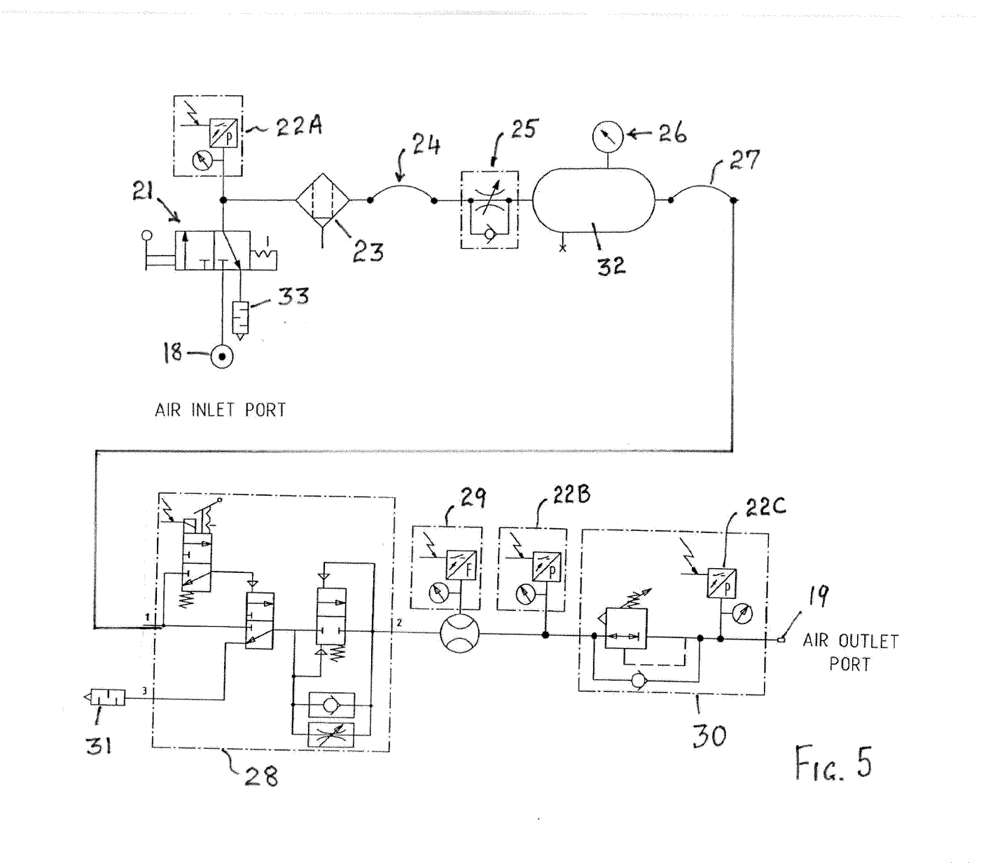

Turning now to FIGS. 4 and 5, the detail of one of the group capacitive regulators 12 will now be described. As seen in FIG. 4, the group capacitive regulator 12 has a frame 16 which supports a 50 litre air tank 32 (or receiver). The frame 16 supports a collection of series connected pneumatic equipment which extends between an air inlet port 18 and an air outlet port 19.

As seen in FIGS. 4 and 5, this equipment consists of a hand operated pressure relief three port valve 21 having a silencer 33, a digital pressure switch 22A, a micro-mist separator with pre-filter 23 which is connected via a flexible hose 24 to a flow controller 25 positioned on the inlet of the tank 32. The tank 32 is provided with a pressure gauge 26 and is connected by another flexible hose 27 to a soft start up valve 28 which includes a lockout and a silencer 31. The final items of equipment consist of a digital flow switch 29, a digital pressure switch 22B and a regulator 30 with back flow function and which includes a digital pressure switch 22C.

The main function of the group capacitive regulator 12 is to decouple the air flow through the branch pipe 14 to the workstation 6 from the air flow through the main supply line 4. This is possible because of the air stored within the air tank 32 so the immediate demand for air by the workstation or machine 6 is provided from the tank 32. Whilst the flow demand of the workstation 6 is intermittent in nature, the re-supplying of air to the air tank 32 can take place more slowly, thus reducing the effect of the individual workstation flow upon the factory supply pressure.

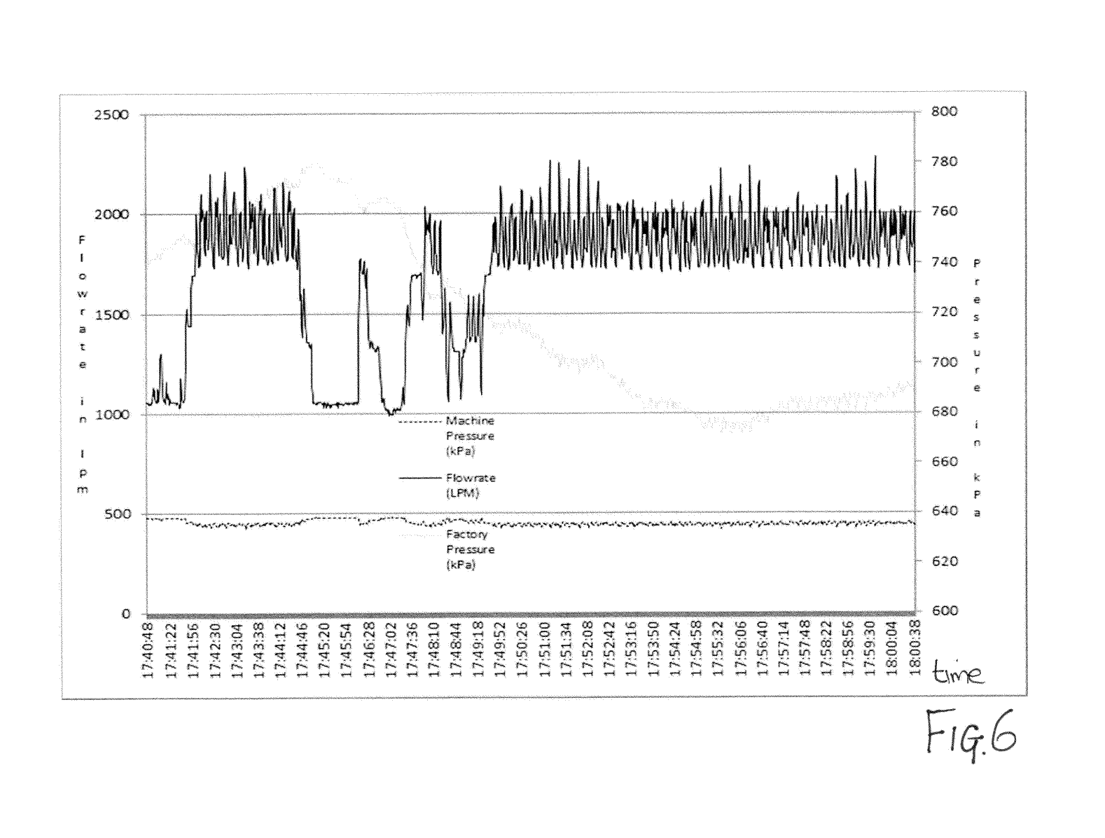

This situation is best illustrated by the graphs of FIG. 6 which show the factory supply pressure at location X as a function of time after the initial installation of the group capacitive regulators 12. The first point to notice is that the factory supply pressure is generally similar to that previous being in the vicinity of 700 kPa. However, the machine pressure is much reduced from approximately 550-650 kPa to the vicinity of 450 kPa and is seen to be decoupled from, or does not follow, variation in the supply pressure. In addition, during short periods of high flow demand, the factory supply pressure is largely unaffected and the machine pressure only drops by approximately 40-50 kPa.

As a consequence of the above decoupling, the regulator setting on the compressor(s) providing the factory air supply can be turned down so that the factory air supply pressure is in the vicinity of 600-650 kPa. Such a reduced pressure provides a sufficient reserve to maintain the machine pressure but results in a very substantial energy saving in the cost of providing the factory air supply.

In addition to the reduced cost of supplying the reduced pressure factory air supply, there are numerous other benefits to be obtained through the installation of the group capacitive regulators 12. For example, because the sub-branch lines 14 are effectively decoupled from each other, this means that the operation of one process line or a workstation/machine 6 does not affect the efficient operation of adjacent process lines, as is often the case with the prior art arrangement of FIG. 1.

Furthermore, because of the relatively small fluctuations in the machine pressure as illustrated in FIG. 6, compared to the large fluctuations in machine pressure as indicated in FIG. 2, it is possible to improve the compressed air efficiency of the workstation 6 within a particular branch line 14 through modifications within the machine or workstation 6, or through changes to the control and operation of the machine or workstation 6.

In addition, since the supply compressor 2 is only required to supply a lower factory supply pressure, this not only lowers the demand on the compressor 2 (and hence the power costs involved in operating the compressor 2) but also reduces maintenance costs and/or postpones the time at which the compressor 2 must be replaced. For new installations a smaller capacity compressor 2 can be provided thereby providing an initial capital saving.

The operating results illustrated in FIG. 6 indicate a 30% reduction in machine or workstation supply pressure from approximately 650 kPa to approximately 450 kPa. The group capacitive regulators 12 also enable the correct volume of compressed air to be provided to satisfy the process requirements of the individual workstation 6, permit lower machine operating pressures, reduce pressure drops at the point of use, and ultimately reduce the overall load on the supply compressor 2.

There are a number of coincidental advantages also arising from the arrangement of FIG. 3. For example, each of the group capacitive regulators 12 has a commonly located hand valve 21 so that in the event of an emergency an entire sub-branch 14 can be isolated. Also all sub-branches have the same isolation switch thereby avoiding the need for complex decision making in the event of an emergency. In addition, the ability to individually isolate each sub-branch 14 means that maintenance work for the detection and rectification of any leaks is considerably simplified and only the workstation(s) 6 of a particular group need have their production stopped during this maintenance activity. This isolation is also Lock Out Tag Out (LOTO) which conforms to Occupational Health and Safety Standards.

In addition, the mist separator/filter 23 provides a single filtration location and thus the multiple smaller filter units normally provided for each of the workstations 6 in the arrangement of FIG. 1, can be removed thereby simplifying maintenance requirements. Furthermore, the air tank 32 effectively removes any significant pressure spikes or fluctuations which would otherwise be experienced by the supply compressor 2 and other workstations 6. This therefore improves the operating conditions of this equipment.

In addition, the soft start up valve 28 enables a controlled introduction of pressurised air to the sub branch line 14 to which the group capacitive regulator 12 is connected. This prevents any elements of these workstations being subjected to instantaneous full pressure on activation of the air supply. Compressed air is thus introduced in a controlled an efficient manner thereby preventing mechanical damage due to “no back pressure” operation of pneumatic actuators. Furthermore, the energy required during the starting of the workstation(s) 6 within a group is reduced during the starting phase. Furthermore, the digital instrumentation provided within the preferred form of group capacitive regulator 12 enables data to be collected by plant supervisory or management systems. Providing this data on a group basis rather than an individual workstation basis is more efficient. Furthermore, each group capacitive regulator 12 is normally installed outside of any guards provided on the corresponding workstation(s) 6 and thus the controls and instruments are readily accessible.

Although not ‘illustrated in the drawings’, it will be understood that the factory pressure can be decreased corresponding to the sum of the improvements of each machine pressure to allow them to be maintained at substantially the same air pressure.

The foregoing describes only one embodiment of the present invention and modifications, obvious to those skilled in the pneumatic air supply art, can be made thereto without departing from the scope of the present invention.

The term “comprising” (and its grammatical variations) as used herein is used in the inclusive sense of “including” or “having” and not in the exclusive sense of “consisting only of”.

1. A method of reducing the supply pressure, and hence cost, of a factory air supply for a factory having a multiplicity of workstations each of which is pneumatically intermittently operable and inter-connected with said factory air supply via a branched network of said factory air supply comprising air supply lines, said factory air supply comprising at least one supply compressor, said method comprising the steps of:
allocating said workstations into a plurality of groups, each of said groups having at least one workstation and each of said groups having a corresponding group branch air line which supplies said group from, and forms part of, said branched network,
interposing between each group branch air line and the remainder of said branched network a group capacitive regulator, each said group capacitive regulator comprising a series connected inlet flow controller, a group air tank and an outlet flow regulator,
whereby the workstation(s) of each group intermittently draw air for their operation from the corresponding said group air tank which is independently replenished from said supply compressor to thereby at least partially isolate the factory air supply from the individual workstations flow demands.

2. The method as claimed in claim 1 including the step of providing at least one of said group capacitive regulators with ancillary pneumatic equipment which need no longer by supplied to each of the workstation(s) of said group.

3. The method as claimed in claim 2, wherein said ancillary pneumatic equipment is selected from the class consisting of filters.

4. The method as claimed in claim 1 wherein at least one of said group branch air lines is not itself branched.

5. The method as claimed in claim 1 wherein at least one of said group branch lines is itself branched.

6. A factory air supply system for a multiplicity of workstations each of which is pneumatically intermittently operable, said system comprising:
at least one supply compressor;
a branched air supply network comprising air supply lines;
a multiplicity of said workstations allocated into a plurality of groups, each of said groups having at least one workstation and each having a corresponding group branch air line which supplies said group from, and forms part of, said branched network;
a group capacitive regulator for each said group interposed between each group branch air line and the remainder of said branched network; and
each said group capacitive regulator comprising a series connected inlet flow controller, a group air tank and an outlet flow regulator.

7. The system as claimed in claim 6 wherein at least one of said group capacitive regulators has ancillary pneumatic equipment which need no longer be supplied to each of the workstations of said group.

8. The system as claimed in claim 7 wherein said ancillary pneumatic equipment is selected from the class consisting of filters.

9. The system as claimed in claim 6 wherein at least one of said group branch air lines is not itself branched.

10. The system as claimed in claim 6 wherein at least one of said group branch air lines is itself branched.

11. A group capacitive regulator comprising a series connected inlet flow controller, a group air tank, and an outlet flow regulator.

12. The regulator as claimed in claim 11 and including a filter.
